(19) United States
(12) Patent Application Publication
(10) Pub. No.: US 2007/0101643 A1
(43) Pub. Date: May 10, 2007

(54) Floral attachment device

(76) Inventors: Nancy Yowney, Sherwood Park (CA); Christina Zelman, Sherwood Park (CA)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/644,783

(22) Filed: Dec. 22, 2006

Related U.S. Application Data
(63) Continuation-in-part of application No. 11/228,815, filed on Sep. 16, 2005, now abandoned.

(51) Int. Cl. A01G 5/00

(52) U.S. Cl. 47/41.15

(57) ABSTRACT

A boutonniere/corsage holder to secure a flower arrangement onto the surface of a piece of clothing, such as a lapel of a suit, is disclosed. The flower holder consists of a thin, elongated, flat body with opposing surfaces, a narrow central portion and widened end portions. The body is adapted to securely receive at the narrow central or entire portion, flower stem wrapping tape for securing the stem or stems of the flower arrangement to one of the surfaces of the body. An anchoring magnet is secured at or within one of the end portions of the body. A securing magnet is used to secure the body to the piece of clothing using the interactive magnetic attractive force between the anchoring magnet and the securing magnet. The magnetic attractive force is sufficient to secure the flower holder and a flower arrangement to the surface while still allowing the user to remove flower arrangement and flower holder without difficulty.

### CROSS-REFERENCE TO RELATED APPLICATIONS

This is a continuation-in-part of U.S. patent application Ser. No. 11/228,815 entitled FLORAL ATTACHMENT DEVICE filed Sep. 16, 2005, the entire contents of which are incorporated herein by reference.

### FIELD OF THE INVENTION

The present invention relates to floral attachment devices, and in particular devices used to secure boutonnieres or corsages to the outside of a surface without the use of pins.

### BACKGROUND OF THE INVENTION

Flowers and other ornaments have been used to personalize a person's dress and are a customary clothing adornment for certain special occasions, such as weddings, graduations, dances and the like.

Traditionally, the flower arrangement is secured to the outer surface of the clothing using standard straight pins that are threaded through the clothing and through the stem of the flower arrangement. Over time, the wearer's clothing is damaged by the weight of the flower arrangement pulling the pin or pins downward and thus deforming or stretching the threads that support the pins. Further, the pins may prick the wearer when the flower arrangement is being applied or prick someone who tries to touch the arrangement. In some cases, clips have been substituted for pins, but the clips crush and abrade the wearer's clothes.

Magnets have been used to secure the flower arrangement to clothing without the use of pins. Typically, a magnet is secured to the stems of the flowers using tape, glue or ribbon. A second magnet is then positioned on the interior of the clothing to secure the flower arrangement to the outer surface of the clothing. Positioning the magnet on the stems of the flower arrangement is cumbersome and it is difficult to position the magnet so that the flower arrangement sits properly on the surface of the clothing while allowing the two magnets to be in sufficient proximity to hold the flower arrangement in place.

Some magnets have been fitted with wire arms that wrap around the stems of the flowers to provide additional support and make it easier to position and attach the magnet to the stems of the flower arrangement, such as described and illustrated in Borthwick, U.S. Pat. No. 3,416,195. Generally, the wire arms are thin, so that they are easily wrapped around the stems and do not interfere with the aesthetics of the flower arrangement. However, the wire arms do not restrict the rotation of the magnet around the longitudinal axis of the stems of the flower arrangement and thus the flower can move out of position when being worn. Further, the wire arms do not provide sufficient support on which to build the flower arrangement.

Another type of magnetic flower holder, having a metal V-shaped cradle with metal arms to hold the flower arrangement in place, is taught in U.S. Pat. No. 5,682,648, issued in the name of Miller on Nov. 4, 1977. As the arms hold the flower arrangement in place by pinning the stems against the back of the cradle, the arms lie across the front of the flower arrangement and are visible from the front, thus interfering with the aesthetics of the flower arrangement.

Another type of magnetic flower holder is described and illustrated in U.S. Patent application publication No. US-2005/0262666 of McIntosh, in the form of a metal or plastic T-shaped holder on which the flower arrangement is built and affixed using flower stem wrapping tape or the like. A rectangular body having a magnet attached to either end of the body is positioned behind the horizontal portion of the T-shaped holder to secure the flower arrangement to the wearer's clothing. In one embodiment of this invention the entire body is made of magnetically attractive metal. The horizontal portion of the T-shaped holder projects beyond the central vertical axis of the stems of a flower arrangement, necessitating the incorporation of additional elements to a flower arrangement to hide the horizontal portion of the body. Indeed, the entire device is bulky, making it difficult to neatly and effectively secure a floral arrangement to it. Further, the vertical portion is rectangular and thus the flower arrangement can slip off the magnetic flower holder if glue or tape is not used to attach the flower arrangement.

### SUMMARY OF THE INVENTION

An object of the invention is to provide an improved flower holder to secure a flower arrangement to a site such as a piece of clothing.

According to one aspect of the invention, there is provided a thin, elongated, flat, non-magnetic and lightweight body having opposing surfaces. The body has a narrow central portion and widened upper and lower end portions. The body is adapted to securely receive at the central narrow portion, or along the entire length, flower stem wrapping tape for securing the stem or stems of the flower arrangement on one of the surfaces of the body. The narrow central portion and widened end portions act to secure the flower stem wrapping tape against becoming dislodged by slipping over the widened lower end portion. An anchoring magnet is secured to the other surface, at the upper end portion of the body. The body is secured to a site by the magnetic attractive forces between the securing magnet and the anchoring magnet. The magnetic attractive forces 15 between the anchoring magnet and the securing magnet releasably secure the holder to the site when a flower arrangement is secured to the flower holder.

According to a further aspect of the invention, there is provided a thin, elongated, flat, non-magnetic and light weight body having opposing surfaces. The body has a narrow central portion and widened upper and lower end portions. The body is adapted to securely receive at the central narrow portion, or along the entire length, flower stem wrapping tape for securing the stem or stems of the flower arrangement on one of the surfaces of the body. The narrow central portion and widened end portions act to secure the flower stem wrapping tape against becoming dislodged by slipping over the widened lower end portion. An anchoring magnet is embedded within and covered by the widened upper end portion and extends under a major portion of this portion's area. The body is secured to a site by the magnetic attractive forces between the securing magnet and the anchoring magnet. The magnetic attractive forces between the anchoring magnet and the securing magnet releasably secure the holder to the site when a flower arrangement is secured to the flower holder.

An advantage of the present invention is that a flower arrangement can be securely attached to the body by tying or taping the stem or stems of the flower arrangement along the narrow central or entire portion of the body. The slimness of the body, laterally, enables the device to be easily and conveniently concealed when wrapped with stem wrapping tape, while at the same time providing excellent support for floral arrangements. The narrow central portion prevents the tape, or any other tying material in strip form, from becoming dislodged and falling off, particularly, the bottom end portion of the body, and also assists in more securely holding the stem or stems securely on the body surface. Using this device does not increase the time it takes the florist to build a boutonniere or corsage.

Another advantage of the present invention is that its thin, linear shape can easily be hidden behind the stem portion of the flower arrangement, and it does not require horizontal elements to be added to the flower arrangement to hide the presence of the holder.

Another advantage of the present invention is the construction of the flower holder so that the flower arrangement and the flower holder do not rotate out of position when worn on a piece of clothing. The device provides a foundation for florists to work with.

The holder may be produced as a disposable or re-usable item, and is an 10 affordable item for the end-user and is a more efficient, time-saving product for the florist to use.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the present patent specification as a whole. For example, it is contemplated that the invention could be used to secure other ornamental objects used to adorn clothes that would be obvious to a person skilled in the art. Further, it will be understood that all dimensions and sizes described herein, both relative and absolute, may be varied within a broad range to provide a holder sized to the desired use. As well, materials described herein are merely intended to be illustrative and are subject to a range of alternatives.

### BRIEF DESCRIPTION OF THE DRAWINGS

These and other advantages of the invention will become apparent upon reading the following detailed description and upon referring to the drawings in which:

FIG. 1 is a perspective view of the preferred embodiment of the flower holder of the present invention, a flower arrangement and stem wrapping tape illustrated in phantom; and

FIG. 2 is a side view of the holder of FIG. 1 secured to a piece of clothing.

FIG. 3 is an exploded perspective view of an alternative embodiment of flower holder in accordance with the present invention;

FIG. 4 is a front view of the body portion of the holder of FIG. 3;

FIG. 5 is a back view thereof;

FIG. 6 is a side view thereof;

FIG. 7 is a top end view thereof; and

FIG. 8 is a bottom end view thereof.

The present invention will now be described by way of a non-limiting description of certain detailed embodiments.

### DETAILED DESCRIPTION OF THE PREFERRED EMBODIMENTS

In the following description, similar features in the drawings have been given identical reference numerals where appropriate. All dimensions described herein are intended solely to illustrate an embodiment. These dimensions are not intended to limit the scope of the invention that may depart from these dimensions.

The invention is illustrated and described in context of holding a flower arrangement. However, it is contemplated that this holder may be used to secure other ornamental objects of appropriate shape to the outside surface of clothing or the like.

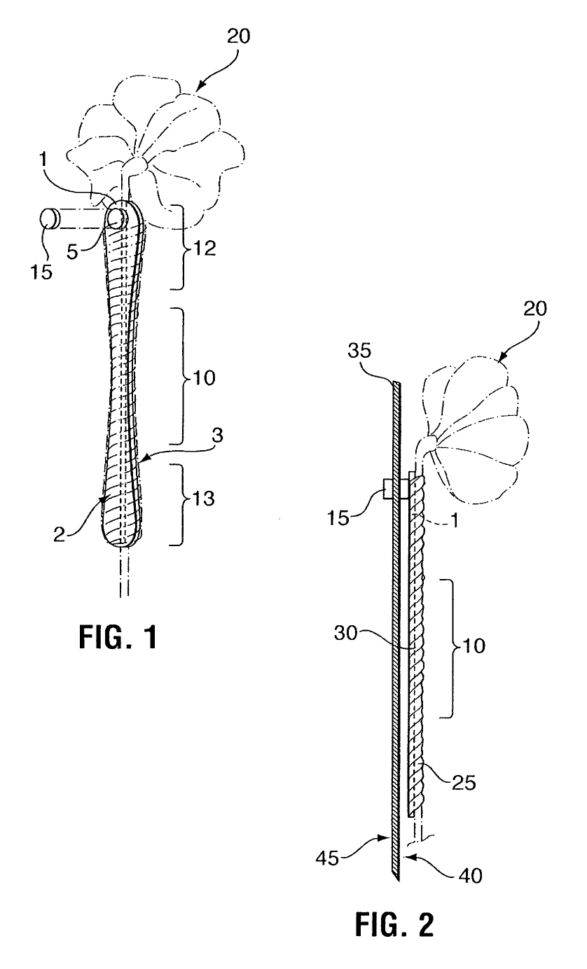

Turning to FIG. 1, there is illustrated a magnetic floral attachment device according to the present invention having a thin, elongated, flat, non-magnetic and lightweight body 1 with opposing surfaces 2 and 3, a narrow central portion 10 and widened upper and lower end portions 12 and 13, respectively. The lateral width of the body, at its central portion may be no more than the width of one or two floral stems. The body is adapted to receive wrapping material 30 for securing the stem or stems of the flower arrangement to the holder. An anchoring magnet 5 of any appropriate size and strength is secured to an upper end portion of the body 12, and a corresponding securing magnet 15 of any appropriate size and strength, again is used to secure the flower arrangement and flower holder at a site, such as on a lapel of a suit or coat, by positioning the securing magnet on the opposite side of the suit fabric from the anchoring magnet 5. Small, but powerful button magnets are preferably used.

The width of the narrow central portion 10 is narrower than either of the widened end portions of the body. In the illustrated embodiment, there is a gradual reduction in the width of the body to result in an edge having a smooth curve leading to the narrow central portion of the body.

The body may be of any color or clear, made of a flexible or semi-rigid non-magnetic material, such as plastic, polymer, resin, glass, paper, wood, cardboard, non-magnetic metal or any such similar substance that would be known to a person skilled in the art to be able to substantially retain the shape of the narrow center portion of the body 10 when the stem or stems of a flower arrangement are secured to it. The body is substantially flat to allow the holder to sit closely to the surface. However, it is contemplated that the edges of the body may be slightly bent to facilitate securing the stems in position on one surface of the body 1.

FIG. 2 illustrates a flower arrangement 20 secured in position to the body 1. The body 1 is secured to the stem of the flower arrangement 25 by means of floral stem wrapping tape 30 wrapped around the narrow central portion 10 or entire body 1 and the stems of the flowers 25. It is contemplated that the flower arrangement 20, alternatively, can be secured to the body 1 with a variety of substances, such as glue, ribbon, string, clips, staples or any other appropriate conventional attachment means. The flower 20 and the body 1 are releasably secured, for example, to the exterior surface 40 of a lapel 35 of a suit, as illustrated, by means of the attraction of the securing magnet 15 placed on the inside of the lapel 35 to the anchoring magnet 5 of the body 1. In the preferred embodiment, the securing magnet 15 is positioned on the interior surface 45 of the piece of clothing 35 opposite the anchoring magnet 5.

As shown in FIGS. I and 2, because of the positioning of the anchoring magnets in the upper end portion 12 of the body 1 when the flower arrangement 20 is attached to the body 1, in most cases, the center of gravity of the combined holder and flower arrangement 20 will be below the anchoring magnet 5. This arrangement stabilizes the holder and flower arrangement when held in position on the suit fabric.

The magnetic attractive forces between the anchoring magnet 5 and the securing magnet 15 are sufficient to firmly secure the flower arrangement to the lapel without damaging the surface. It is also contemplated that a plurality of magnets can be used in place of a single anchoring or a single securing magnet.

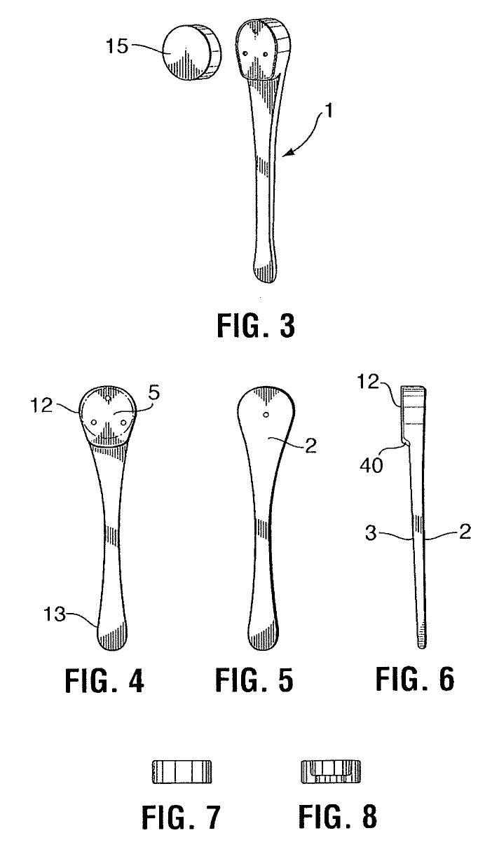

Turning to the alternative embodiment illustrated in FIGS. 3 to 8, the floral attachment device comprises a thin, elongated, flat, non-magnetic and lightweight body 1, prefereably made of plastic, having opposed surfaces 2 (for supporting the stem or stems of one or more flowers) and 3 (at the back of body 1). Body 1 is provided with a narrow central portion 10 and widened upper and lower end portions 12 and 13 respectively, although upper end portion 12 is wider than lower end portion 13 (see for example FIG. 2). Again the lateral width of body 1, at its central portion, may be no more than the width of one or two floral stems. In this case, anchoring magnet 5 (seen in phantom in FIG. 4) is embedded within and covered by the upper end portion 12 of body 1, anchoring magnet 5 being again a small, but powerful button magnet and of an area that extends under a major portion of the area of upper end portion 12, as illustrated.

As can be seen in FIG. 6, back surface 3, behind front surface 2 which supports the stem or stems of the flower or flowers when secured to body 2, is gradually tapered towards surface 2 over most of its length, and is stepped, at 40, towards upper end 12 so that magnet 5 is completely contained within and covered by the material forming body 1, at this end.

Because the body 1 is relatively light, and extremely thin, the device of FIGS. 3 to 8 can be readily camouflaged behind floral stems and entirely wrapped with portions of the stems within floral stem wrapping tape, and relatively small button magnets 5 and 15 can provide extremely strong interactive attractive forces, to readily and firmly secure the flower arrangement to the lapel or other fabric material.

Although the present invention has been described by way of a detailed description in which various embodiments and aspects of the invention have been described, it will be seen by one skilled in the art that the full scope of this invention is not limited to the examples presented herein. The invention has a scope which is commensurate with the claims of this patent specification including any elements or aspects which would be seen to be equivalent to those set out in the accompanying claims.

What is claimed is:

1. A floral attachment device to secure a flower arrangement having a stem or stems in position at a site comprising:
a thin, elongated, flat, non-magnetic and lightweight body having opposing surfaces, a narrow central portion and widened upper and lower end portions, the body adapted to securely receive at the central narrow portion, or along the entire length, flower stem wrapping tape for securing the stem or stems of the flower arrangement on one of the surfaces of the body, said narrow central portion and widened end portions acting to secure the flower stem wrapping tape against becoming dislodged by slipping over said widened lower end portion;
an anchoring magnet embedded within and covered by the widened upper end portion and extending under a major portion of this portion's area; and
a securing magnet,
whereby, in use, the body and the flower arrangement are releasably held to the site by magnetic attractive forces between the anchoring magnet and the securing magnet.

2. A floral attachment device according to claim 1 in combination with flower stem wrapping tape for securing the stem or stems of the flower arrangement on one of the surfaces of the body.

3. A floral attachment device according to claim 1 wherein the surface of the body on which the flower arrangement is to be secured is flat, and wherein a portion of the other surface of the body, in the vicinity of the embedded anchoring magnet in the widened upper end portion, is upwardly raised over the remaining portion of said other surface.

4. A floral attachment device according to claim 1 wherein the body is made of plastic.

5. A floral attachment device according to claim 1 wherein the upper end portion is wider than the lower end portion.

6. A floral attachment device in accordance with claim 1 in combination with a flower arrangement having one or more stems, the stem or stems of the flower arrangement supported on said one of the surfaces of the body and secured thereto by said flower stem wrapping tape wrapped about the body and stem or stems.
